(19) United States
(12) Patent Application Publication
(10) Pub. No.: US 2018/0136173 A1
(43) Pub. Date: May 17, 2018

(54) CONDITION ASSESSMENT DEVICE, CONDITION ASSESSMENT METHOD, PROGRAM RECORDING MEDIUM

(71) Applicant: NEC CORPORATION, Tokyo (JP)

(72) Inventors: Masatake TAKAHASHI, Tokyo (JP); Shin TOMINAGA, Tokyo (JP); Kanta MIYAKE, Tokyo (JP)

(73) Assignee: NEC CORPORATION, Tokyo (JP)

(21) Appl. No.: 15/573,217

(22) PCT Filed: May 20, 2016
(86) PCT No.: PCT/JP2016/002459

§ 371 Date: Nov. 10, 2017

(30) Foreign Application Priority Data
May 20, 2015 (JP) 2015-103005

(51) Int. Cl. G01N 29/42; G01N 29/04

(52) U.S. Cl. CPC G01N 29/42; G01N 2291/262; G01N 29/04

(57) ABSTRACT

[Problem] To assess condition of a pipe with a high degree of accuracy.

[Solution] A condition assessment device 100 includes a detection unit 110 that detects a plurality of waves propagating through a pipe or fluid in the pipe and each having a different propagation distance at the pipe or a connection portion of the pipe, a determination unit 120 that determines a predetermined frequency band based on a difference between the plurality of the waves detected by the detection means; and an assessment unit 130 that assesses condition of the pipe using a physical quantity related to the frequency band determined by the determination means as an index.

### TECHNICAL FIELD

The present invention relates to assessment of condition of an object.

### BACKGROUND ART

As a method of nondestructive testing of a structure, for example, an organoleptic test based on human audibility is used. However, inspections carried out by humans may involve danger depending on a type of a structure such as being buried in the ground or being installed at high place. In addition, error due to ability of testers (difference among individuals) may occur in an organoleptic test.

On the other hand, as a test method using a machine, for example, technique described in PTL 1 or PTL 2 is used. PTL 1 discloses technique for detecting an acoustic disturbance that propagates through 2 points on a pipe and calculating a wall thickness parameter of the pipe based on a measured value and a predicted value of the acoustic disturbance. Further, PTL 2 discloses technique for installing a vibration exciter and two vibration sensors on a pipe, and calculating a vibration propagation velocity using correlation technique.

### CITATION LIST

### Patent Literature

[PTL 1] Japanese Patent Application Laid-Open No. 2013-061350
[PTL 2] Japanese Patent Application Laid-Open No. 1999-210858

### SUMMARY OF INVENTION

### Technical Problem

The technique described in PTL 1 or PTL 2 has an issue that an influence of disturbance and an ancillary facility cannot be eliminated from measurement result. For example, when installing a sensor to a buried pipe, it is often difficult to directly attach the sensor on the pipe. In such a case, the sensor is usually installed on an ancillary facility of the pipe such as a hydrant, a valve. As a result, information from the ancillary facility is superimposed to information measured at the sensor, in addition to information from the pipe. In addition, vibration propagating to a buried pipe may include vibration or noise caused by running a car.

An object of the present invention is to provide a technique for assessing condition of a pipe with high accuracy.

### Solution to Problem

The present invention provides a condition assessment device includes detection means for detecting a plurality of waves propagating through a pipe or fluid in the pipe and each having a different propagation distance at the pipe or a connection portion of the pipe, determination means for determining a predetermined frequency band based on a difference between the plurality of the waves detected by the detection means, and assessment means for assessing condition of the pipe using a physical quantity related to the frequency band determined by the determination means as an index.

The present invention provides a condition assessment method includes: detecting a plurality of waves propagating through a pipe or fluid in the pipe and each having a different propagation distance at the pipe or a connection portion of the pipe, determining a predetermined frequency band based on a difference between the plurality of the waves being detected, and assessing condition of the pipe by using a physical quantity of the determined frequency band as an index.

The present invention provides a computer-readable program recording medium recording a program causing a computer to execute: a step of acquiring a signal representing a plurality of waves propagating through the pipe or fluid in the pipe and each having a different propagation distance, detected at the pipe or a connection portion of the pipe, a step of determining a predetermined frequency band based on a difference between the plurality of waves represented by the plurality of the signals being acquired, and a step of assessing condition of the pipe using a physical quantity of the determined frequency band as an index.

### Advantageous Effects of Invention

According to the present invention, condition of a pipe can be assessed with high accuracy.

### BRIEF DESCRIPTION OF DRAWINGS

FIG. 1 is a block diagram illustrating a configuration of a condition assessment device 100.

FIG. 2 is a figure illustrating an example of a configuration of a detection unit 110.

FIG. 3 is a figure illustrating an example of a configuration of a detection unit 110.

FIG. 4A is a pattern diagram for describing an analysis frequency band.

FIG. 4B is a pattern diagram for describing an analysis frequency band.

FIG. 4C is a pattern diagram for describing an analysis frequency band.

FIG. 5 is a flowchart illustrating an example of a determination process.

FIG. 6 is a flowchart illustrating an example of an assessment process.

FIG. 7 is a block diagram illustrating a configuration of a condition assessment device 200.

FIG. 8A is a figure illustrating an example of a relationship between a condition assessment device 200 and a structure to be an assessment object.

FIG. 8B is a figure illustrating an example of a relationship between a condition assessment device 200 and a structure to be an assessment object.

### DESCRIPTION OF EMBODIMENTS

### First Example Embodiment

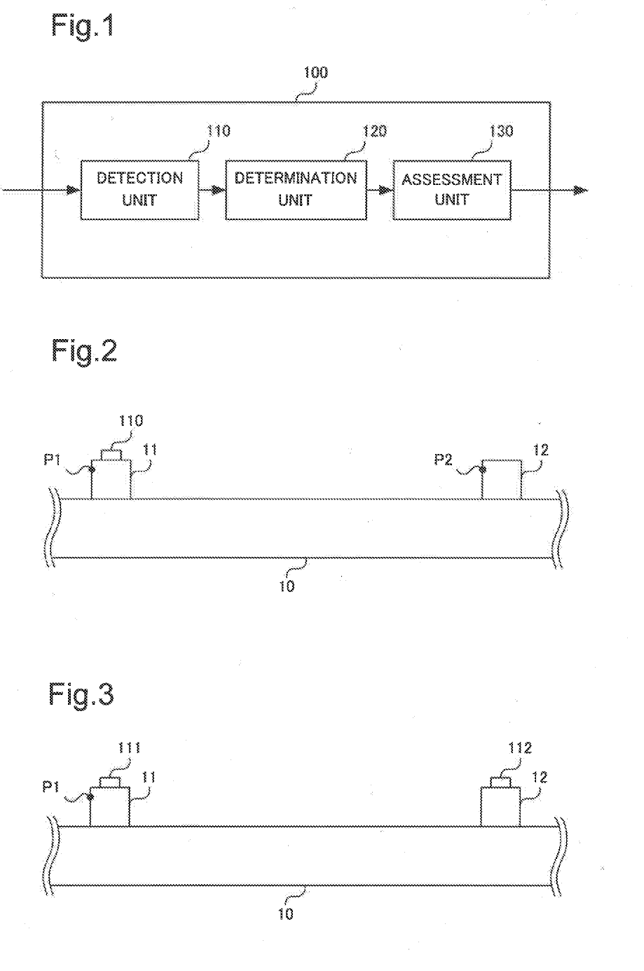

FIG. 1 is a block diagram illustrating a configuration of a condition assessment device 100 according to an example embodiment of the present invention. The condition assessment device 100 is an information processing device for assessing condition of a pipe. The condition assessment device 100 includes a detection unit 110, a determination unit 120, and an assessment unit 130.

In this exemplary embodiment, the pipe is a tubular object installed at a predetermined position. The pipe is also called a tubular body, a plumbing, or a piping. Fluid exists in the pipe. Here, the fluid is liquid or gas, and for example, the fluid is water or air. Material or a shape of the pipe, or a type of the fluid are not limited in particular.

In this exemplary embodiment, the condition of the pipe is a condition with respect to a defect of the pipe. More specifically, the condition of the pipe represents presence or absence of a defect on the pipe, a degree of the defect, a position of the defect, and the like. The condition assessment device 100 may be used for assessing a degree of defect and determining presence of a sign of defect, although the condition assessment device 100 may be a device for determining the presence or absence a defect on the pipe. Note that, the defect means not only condition of lacking safety as a structure but also condition being different from normal or ideal condition (typically, a condition such that quality or performance is deteriorated).

Further, the defect can be categorized into a plurality of types. For example, variation of mechanical property such as thickness, density, stiffness of a wall at a specific position of the pipe, or variation of cross-sectional shape at a specific position caused by deposition of solid matter that deposited from fluid can be enumerated as types of the defect. Further, a crack or a hole generated at a specific position, fluid leakage from the crack or the hole, and the like are included in the defect of the pipe.

The detection unit 110 detects a wave (undulation) that propagates through the pipe or the fluid in the pipe. In other words, the wave here is a wave propagating through at least one of the pipe or the fluid in the pipe as media. The detection unit 110 detects the wave propagating through the pipe or the fluid in the pipe as an electric signal. This electric signal represents vibration at the specific point.

The detection unit 110 includes one or more sensors which detect a wave propagating through the pipe or the fluid. For example, a vibration sensor of piezoelectric type or an electromagnetic type, a pressure sensor such as a water pressure sensor or the like, an ultrasonic sensor, an underwater microphone (a hydrophone), or the like may be used for the sensor of the detection unit 110. The detection unit 110 may use a plurality of types of sensors for wave detection.

The detection unit 110 detects a plurality of waves of which propagation distances in the pipe or the fluid are different from each other. For example, in one aspect, the detection unit 110 detects a first wave occurred at a first point and a second wave occurred at a second point located far (away) from the first point at one position. In another aspect, the detection unit 110 detects the wave occurred at one point at a first position and a second position located far from the first position. For convenience of explanation, the wave detected at the first position in this aspect is called a “first wave” and the wave detected at the second position is called a “second wave” below. Even in each of these aspects, the first wave includes vibration that corresponds to a self-response, and the second wave includes vibration that corresponds to a mutual response.

FIG. 2 and FIG. 3 are figures illustrating an example of a configuration of the detection unit 110. FIG. 2 is a figure illustrating an example of a configuration for a case where waves occurred at a plurality of points are detected at one position. On the other hand, FIG. 3 is a figure illustrating an example of a configuration for a case where a wave occurred at one point is detected at a plurality of positions.

In FIG. 2 and FIG. 3, connection portions 11 and 12 are provided ono a pipe 10. For example, the connection portions 11 and 12 are connection portions for connecting two pipes 10 to each other or ancillary facilities connected to the pipe 10. Specifically, the connection portions 11 and 12 are flanges, valves, hydrants, water shut-off valves, or the like.

In the example illustrated in FIG. 2, the detection unit 110 is deployed at a predetermined position of the connection portion 11. In this case, a user excites each of the connection portions 11 and 12 using a vibration generator or a hammer. Here, “excite” represents to excite vibration. A vibration excitation point P1 (first point) is located in the vicinity of deployment position of the detection unit 110. Specifically, the vibration excitation point P1 is a point within approximately 1 meter of the deployment position of the detection unit 110, and typically, a range of between 50 m to 500 m inclusive. On the other hand, a vibration excitation point P2 (second point) is set to the connection portion 12, not the connection portion 11. Specifically, the vibration excitation point P2 is a point within a range of between approximately 1 m to 10 km inclusive, and typically, a range of between 50 m to 500 m inclusive.

The vibration excitation points P1 and P2 are not necessarily limited to set within the range of value as described above. The vibration excitation points P1 can be set any point as long as it is closer to the deployment position of the detection unit 110. However, it is preferable that the vibration excitation point P2 is set at a certain distance from the vibration excitation point P1, so as to differentiate propagation distances of the wave generated by the excitation.

In the example illustrated in FIG. 3, the detection unit 110 is configured to include sensors 111 and 112. The sensor 111 is attached to the connection portion 11. On the other hand, the sensor 112 is attached to the connection portion 12. The sensors 111 and 112 detect a wave occurred at the vibration excitation point P1. The sensor 112 detects a wave occurred at the vibration excitation point P1 and propagating through the pipe 11 (or the fluid in the pipe 11).

The determination unit 120 determines a frequency band used for assessment of condition of the pipe. In other words, the determination unit 120 determines a frequency band used for the assessment performed by the assessment unit 130. For convenience of explanation, the frequency band determined by the determination unit 120 is hereinafter referred to as an “analysis frequency band”.

The determination unit 120 determines the analysis frequency band based on difference between a plurality of the waves detected by the detection unit 110. In other words, the determination unit 120 determines the analysis frequency band based on difference of physical quantities that may be different from each other for each frequency of a plurality of the waves, detected by the detection unit 110. In more detail, the determination unit 120 compares values of the physical quantities (for example, the vibration acceleration) of a plurality of the waves with different propagation distances in the pipe or the fluid for each frequency, and determines the analysis frequency band based on its difference.

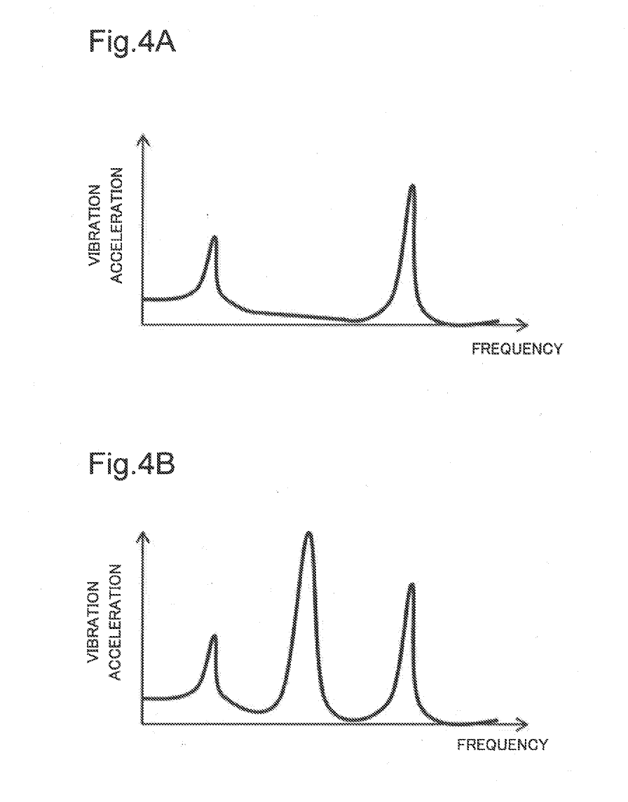

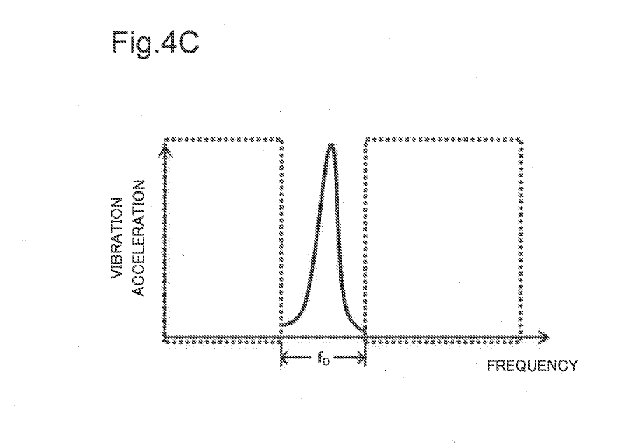

FIGS. 4A to 4C are pattern diagrams for describing the analysis frequency band. FIG. 4A and FIG. 4B respectively represent the first wave and the second wave. FIG. 4C represents an analysis frequency band f0 determined based on FIG. 4A and FIG. 4B. FIGS. 4A to 4C represent a relationship between a frequency of the wave (horizontal axis) and a vibration acceleration (vertical axis).

As illustrated in FIG. 4A and FIG. 4B, the first wave and the second wave detected as vibration at the specific point have a peak vibration acceleration at a plurality of frequencies. In addition, while the first wave and the second wave have the peak vibration acceleration at common frequency, a frequency at which only the second wave has the peak vibration acceleration exists. The frequency at which the peak appears in both the first wave and the second wave is related to noise in a condition assessment of the pipe. Accordingly, the determination unit 120 determines the analysis frequency band by searching for a frequency band at which the second wave has the peak vibration acceleration while the first wave does not have the peak vibration acceleration.

FIG. 4A and FIG. 4B illustrate the first wave and the second wave in a simplified manner. The first wave and the second wave may include more noise components in practice, and may include a plurality of components in which a peak appears in only one of them. When a plurality of frequency bands in which the second wave has the peak vibration acceleration while the first wave does not have the peak vibration acceleration exist, the determination unit 120 may determine the frequency band in which the difference between the peak vibration acceleration of the first wave and the peak vibration acceleration of the second wave is maximum as the analysis frequency band.

The assessment unit 130 assesses the condition of the pipe. The assessment unit 130 uses a physical quantity related to the analysis frequency band determined by the determination unit 120 as an index of the assessment. A frequency, a sharpness (Q value), a propagation time, a speed of sound, a water pressure, or the like can be used as the physical quantity used for the assessment by the assessment unit 130. The physical quantity used for the assessment performed by the assessment unit 130 may vary depending on a material of the pipe or a type of defect of an assessment object.

For example, when a certain type of defect occurs, the frequency of the analysis frequency band shifts. In this case, the condition assessment device 100 excites vibration having a peak at a specific frequency in the analysis frequency band, and assesses the condition of the pipe by determining whether or not the detected frequency is shifted. When the propagation time of the wave varies depending on the defect, the condition assessment device 100 excites the vibration at the specific point at which the propagation time (when the pipe has no defect) is known, and assesses the condition of the pipe based on actual propagation time of the component in the analysis frequency band.

Further, the assessment unit 130 outputs an assessment results, that is, information representing the condition of the pipe. This information is hereinafter referred to as “condition data”. The assessment unit 130 transmits the condition data to, for example, an external device connected to the condition assessment device 100 via a wired or wireless manner. The condition data represents presence of a defect, a degree of defect, a defect position, a type of defect, and the like, and includes at least one of them.

Note that, the determination unit 120 and the assessment unit 130 can be implemented by a software process. In other words, the determination unit 120 and the assessment unit 130 can be implemented by, for example, executing a predetermined program on an information processing device including an arithmetic processing device such as a CPU (Central Processing Unit) and a memory.

The configuration of the condition assessment device 100 has been described above. The condition assessment device 100 including such configuration performs a determination process for determining the analysis frequency band, and an assessment process for assessing the condition of the pipe by using the analysis frequency band determined in the determination process. Note that the determination process and the assessment process are not necessarily performed serially. In other words, the user obtains the analysis frequency band in advance by performing the determination process to a certain pipe by using the condition assessment device 100, and after that (for example, another day), may perform the assessment process using this analysis frequency band. Further, when the determination process and the assessment process are performed continuously, the condition assessment device 100 may assess the condition of the pipe by using the second wave.

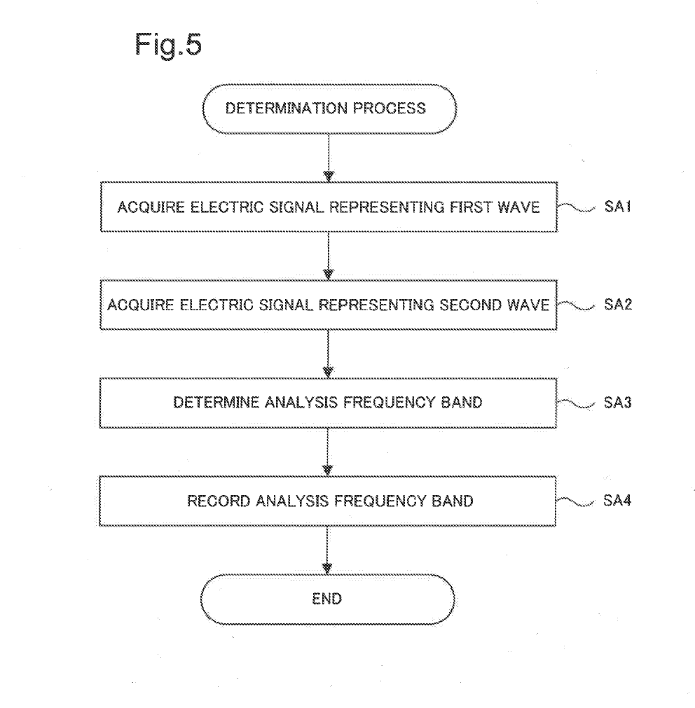

FIG. 5 is a flowchart illustrating an example of the determination process performed by the determination unit 120. The determination unit 120 acquires the electric signal indicating the first wave and the electric signal indicating the second wave (steps SA1 and SA2). Order of the processes of steps SA1 and SA2 can be reversed.

Next, the determination unit 120 determines the analysis frequency band based on the electric signals acquired in steps SA1 and SA2 (step SA3). The method for determining the analysis frequency band is as described above with reference to FIGS. 4A to 4C. The determination unit 120 records the analysis frequency band determined in this way in a predetermined storage area (step SA4).

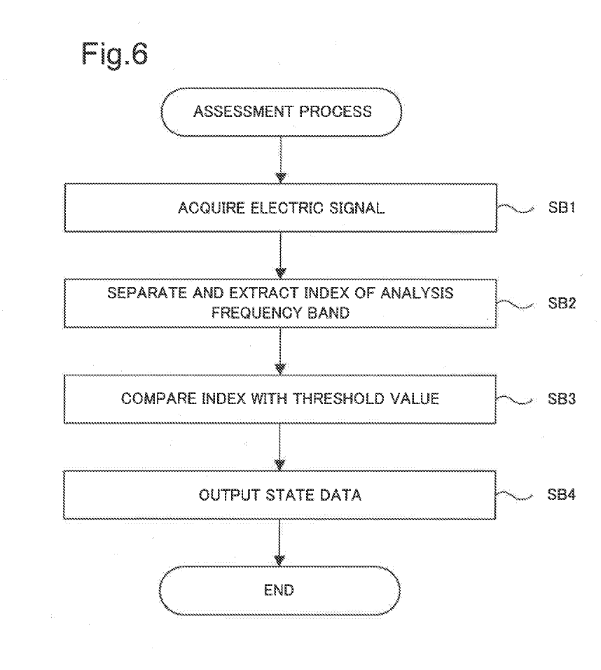

FIG. 6 is a flowchart illustrating an example of the assessment process executed by the assessment unit 130. The assessment unit 130 acquires the electric signal detected by vibrating a predetermined point of the pipe (step SB1). As described above, this electric signal may be an electric signal representing the second wave.

Next, the assessment unit 130 reads out the analysis frequency band recorded in the predetermined storage area by the determination process, and separates and extracts an index of the frequency band used for the assessment from the electric signal acquired in step SB1 (step SB2). A well-known signal processing technology such as a digital filter is used for the extraction of this index.

Then, the assessment unit 130 compares the index extracted in step SB2 with a predetermined threshold value (step SB3). The threshold value may vary for each index or each type of defect used for the assessment. The threshold value is set stepwisely according to the degree of defect when assessing the degree of defect. For example, this threshold value may be calculated by using a value of the index obtained in advance when the pipe is in normal condition, or acquired by referring to the value recorded in the database in advance.

Finally, the assessment unit 130 outputs the condition data according to a result of the comparison in step SB3 (step SB4). For example, the assessment unit 130 outputs the condition data representing that it has a defect when the index extracted in step SB2 exceeds the predetermined threshold value, and the condition data representing that it has no defect when the index is equal to or smaller than the threshold value. Alternatively, the assessment unit 130 may assess the condition of the pipe for each type of a plurality of defects, and output the condition data in which the condition of the pipe is classified into some levels (for example, the evaluation value obtained by evaluating the condition of the pipe on a rank out of ten) based on a plurality of results of assessment.

As described above, in this exemplary embodiment, the analysis frequency band is determined, the condition of the pipe is assessed based on the physical quantity of the frequency band, and thereby assessment accuracy can be improved. This is because the analysis frequency band is appropriately determined and thereby the influence of the disturbance and the ancillary facility can be suitably eliminated.

Generally, the frequency band suitable for the analysis of the condition of the pipe is a frequency band in which a change of vibration propagation characteristic caused by the condition of the pipe propagates sufficiently far. However, an attenuation of the vibration propagating through the pipe or the fluid in the pipe according to propagation distance varies depending on the frequency band.

A frequency band suitable for analysis of the condition of the pipe can be approximately estimated by a calculation based on material of the pipe or the type of fluid in the pipe, or a calculation of frequency characteristic using a pipe with no defect. However, there is a case such that the condition of the pipe cannot be analyzed in detail using a frequency band which is appropriately estimated, since bandwidth of the approximately calculated frequency band is too wide.

On the other hand, the condition of the pipe can be analyzed by detecting a vibration response (mutual response) of a wave propagating through the pipe or the like from a distant place. However, noise reflecting a vibration response (self response) in vicinity of the vibration detection point may be superimposed on the vibration response, in addition to mutual response to be originally detected. A cause for such noise may conceivably include mechanical resonance of the structure in the vicinity of the vibration detection point, disturbance, the multiple reflection of vibration arriving at the point, or the like. Therefore, it is difficult to properly analyze the condition of the pipe by simply detecting the vibration response of wave propagating from a distant place.

Thus, the condition assessment device 100 detects the first wave that may correspond to self response and the second wave that may correspond to the mutual response, and determines the analysis frequency band based on difference between these waves. Accordingly, the condition assessment device 100 can specify frequency band having a bandwidth suitable for assessment of the condition of the pipe, and detect change of vibration propagation characteristic of the pipe.

### Second Example Embodiment

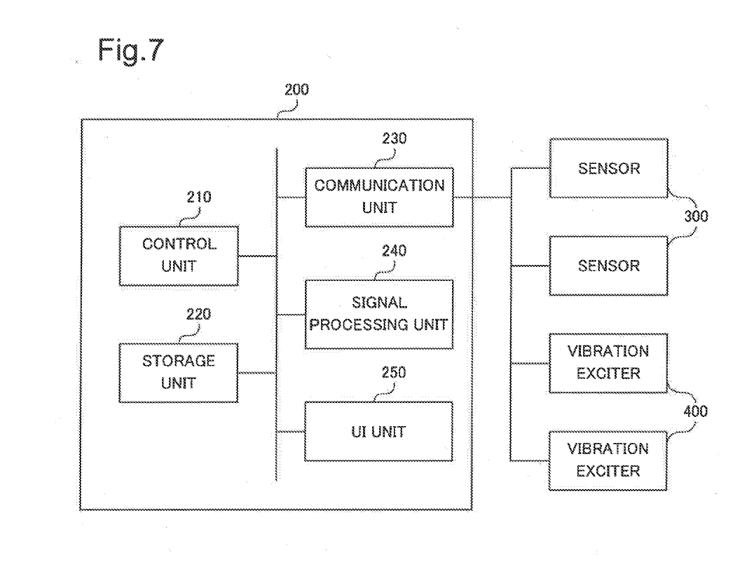

FIG. 7 is a block diagram illustrating a hardware configuration of a condition assessment device 200 according to another example embodiment of the present invention. The condition assessment device 200 includes a control unit 210, a storage unit 220, a communication unit 230, a signal processing unit 240, and a UI (User Interface) unit 250. One or more sensors 300 and vibration exciters 400 can be connected to the condition assessment device 200. Functions corresponding to the determination unit 120 and the assessment unit 130 described above can be implemented by the control unit 210 or the signal processing unit 240 in the condition assessment device 200.

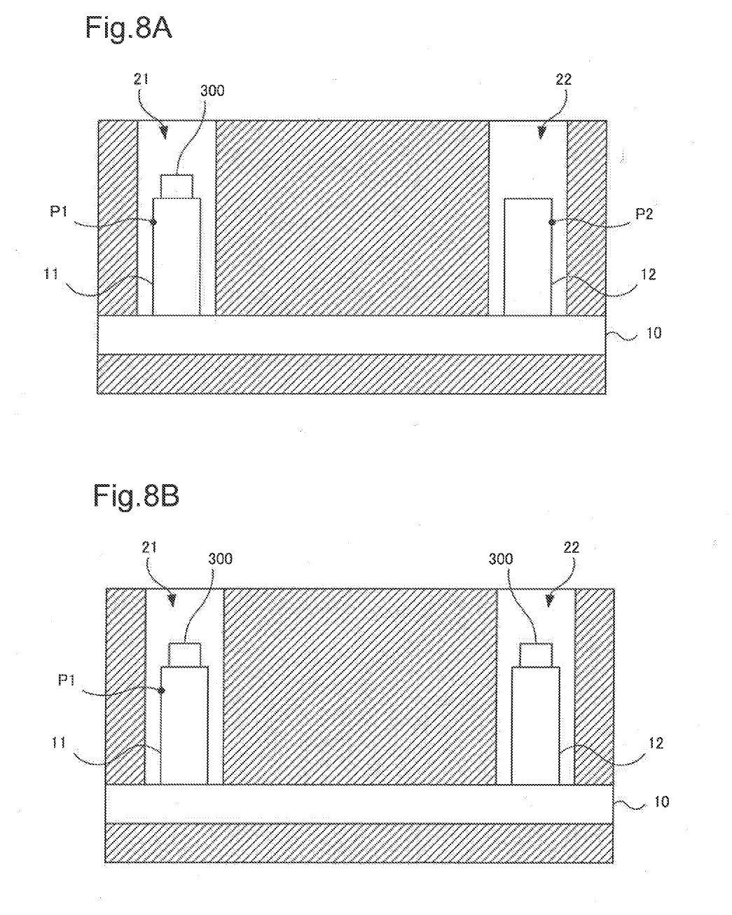

FIGS. 8A and 8B are figures illustrating an example of a relationship between the condition assessment device 200 and a structure to be an assessment object. In this example embodiment, it is assumed that the pipe 10 is buried under the ground. The connection portions 11 and 12 are provided in manholes 21 and 22. The user enters the manholes 21 and 22 and installs the sensor 300 or the vibration exciter 400.

In the example illustrated in FIG. 8A, the sensor 300 is installed only on the connection portion 11. In this case, the vibration exciter 400 is installed at the first point P1 and the second point P2. On the other hand, the example illustrated in FIG. 8B illustrates a case where the sensor 300 is installed on the connection portions 11 and 12. In this case, the vibration exciter 400 is installed at the first point P1.

The control unit 210 controls an operation of each unit of the condition assessment device 200. The control unit 210 includes, for example, an arithmetic processing device such as a CPU and a memory, and controls the operation of each unit by executing a predetermined program. The storage unit 220 corresponds to an auxiliary storage device, and stores data used by the control unit 210. For example, the storage unit 220 is used for recording a program and an analysis frequency band.

The communication unit 230 transmits/receives the data to/from an external device. One or more sensors 300 are included in the external device here. The sensor 300 corresponds to the detection unit 110 according to the first example embodiment. Data communication performed by the communication unit 230 may be a wired or wireless communication.

One or more vibration exciters 400 are included in the external device communicating with the communication unit 230. The vibration exciter 400 is installed on the pipe or the connection portion (in the example illustrated in FIG. 8A, the first point P1) by the user and excites vibration of the pipe or the connection portion. Vibration excited by the vibration exciter 400 excites may include an impulse wave, a sinusoidal wave or a chirp wave. When the user excites the pipe or the connection portion with a hammer or the like, the vibration exciter 400 is not necessary.

The signal processing unit 240 performs a predetermined signal process. For example, the signal processing unit 240 performs the determination process described above. The signal processing unit 240 may not be implemented by an independent hardware unit, and may be implemented by a software process executed by the control unit 210.

The UI unit 250 receives an input from a user, and outputs information to the user. For example, the UI unit 250 includes an input device such as a button or a switch. The UI unit 250 includes an output device such as a display, a lamp, or a speaker.

The configuration of the condition assessment device 200 is as described above. The condition assessment device 200 is capable of executing the determination process and the assessment process, similarly to the condition assessment device 100 according to the first example embodiment. The user may input information required for the assessment by using the condition assessment device 200. For example, the user may input information related to the pipe to be the assessment object (such as its material) and information related to the fluid in the pipe.

The condition assessment device 200 is capable of reporting information according to the condition data to the user. For example, the condition assessment device 200 is capable of reporting information related to the condition of the pipe in a visual way (that is, displaying), or reporting the information by voice.

Note that, when the information related to the pipe or the fluid is inputted by the user, the condition assessment device 200 may specify an approximate number of the analysis frequency band using the information. This approximate number is a value indicating a frequency range determined according to the pipe or the fluid in advance. For example, the approximate number of the analysis frequency is 1 Hz to 2 kHz inclusive for a metal pipe, and 1 Hz to 500 Hz inclusive for a plastic pipe.

When the condition assessment device 200 specifies the approximate number of the analysis frequency band, the condition assessment device 200 determines the analysis frequency band based on the range indicated by the approximate number. In other words, in determining the analysis frequency band, when the peak vibration acceleration exists out of the range indicated by the round number, the condition assessment device 200 eliminates the frequency band in which such peak appears from the analysis frequency band. It is highly likely that such peak is due to noise.

This example embodiment may provide the operation and advantageous effect similar to the first example embodiment. According to this example embodiment, it is possible to reduce a possibility of performing the assessment using an inappropriate analysis frequency band, by determining the analysis frequency band within the range indicated by the approximate number determined in advance.

### Modification Example

The example embodiment of the present invention is not limited to the example embodiment described above. The present invention can be carried out according to an embodiment illustrated in the following modification example, in addition to the above-described example embodiments. Further, the technique described in each example embodiment and each modification example may be combined with each other, or technique may be partially replaced, if needed.

(1) In the present invention, vibration by a user or a vibration exciter is not necessarily required. For example, when the pipe is buried under the ground as in the second example embodiment, a vibration generated by a vehicle running on the ground may be used as a vibration source. Specifically, when the vehicle runs on a manhole cover on the ground, the vibration of the manhole cover may be conducted to the pipe and the connection portion under the ground. The analysis frequency band may also be determined by the vibration conducted to the pipe and the connection portion in this way.

For example, in the example illustrated in FIG. 8B, when the vehicle runs on the manhole cover of the manhole 21, the condition assessment device 200 is capable of detecting the first wave caused by the vibration of the manhole cover at the first point P1, and detecting the second wave caused by the vibration of the manhole cover and propagated via the pipe 10 at the second point P2. The condition assessment device 200 may determine the analysis frequency band based on a difference between these waves.

(2) The present invention can be applied to an object other than the pipe. In the present invention, the object to be the assessment target may be an object other than a hollow object, for example, the object may be a structure having a pillar shape or a rod shape. Further, in the present invention, the object to be the assessment target may not be necessarily the object buried under the ground. For example, it may be installed on the ground or in the water.

(3) The condition assessment device according to the present invention may be implemented by combining a plurality of devices. For example, the condition assessment device 100 according to first example embodiment may be composed of separately configuring each of the detection unit 110, the determination unit 120, and the assessment unit 130. Alternatively, in the condition assessment device 200, the UI unit 250 can be implemented on another device than other configuration, so that the user can remotely operate or and confirm the assessment result.

(4) The present invention can also be provided as a method for assessing a condition using the condition assessment device, or a program which causes a computer to function as all or a part of the condition assessment device, in addition to the condition assessment device. The program according to the present invention may be provided in a form recorded in a predetermined recording medium or, in a form to be downloaded from a server device via a network such as the Internet.

The present invention has been described above by using the above-described example embodiment as an exemplary example. However, the present invention is not limited to the example embodiments described above. Various changes in the configuration or details of the present invention that can be understood by those skilled in the art can be made without departing from the scope of the present invention.

This application claims priority from Japanese Patent Application No. 2015-103005, filed on May 20, 2015, the disclosure of which is hereby incorporated by reference in its entirety.

### REFERENCE SIGNS LIST

10 pipe
11, 12 connection portion
100, 200 condition assessment device
110 detection unit
111, 112 sensor
120 determination unit
130 assessment unit
210 control unit
220 storage unit
230 communication unit
240 signal processing unit
250 UI unit
300 sensor
400 vibration exciter

1. A condition assessment device, comprising:
at least one processing component configured to:
detect a plurality of waves propagating through a pipe or fluid in the pipe and each having a different propagation distance at the pipe or a connection portion of the pipe;
determine a frequency band based on a difference between the plurality of the waves and
assess condition of the pipe using a physical quantity related to the frequency band determined as an index.

2. The condition assessment device according to claim 1, wherein
the at least one processing component further configured to:
determine the frequency band within a range of the frequency determined according to the pipe or the fluid.

3. The condition assessment device according to claim 1, wherein
the at least one processing component further configured to:
detect a first wave occurred at a first point and a second wave occurred at a second point located far from the first point at one position.

4. The condition assessment device according to claim 1, wherein
the at least one processing component further configured to:
detect a wave occurred at one point at a first position and a second position located far from the first position.

5. The condition assessment device according to claim 4, wherein a vibration exciter is installed at the first point and the second point.

6. A condition assessment method, comprising:
detecting a plurality of waves propagating through a pipe or fluid in the pipe and each having a different propagation distance at the pipe or a connection portion of the pipe;
determining a frequency band based on a difference between the plurality of the waves being detected; and
assessing condition of the pipe by using a physical quantity of the determined frequency band as an index.

7. A non-transitory computer-readable recording medium recording a program causing a computer to execute:
a step of acquiring a signal representing a plurality of waves propagating through the pipe or fluid in the pipe and each having a different propagation distance, detected at the pipe or a connection portion of the pipe;
a step of determining a frequency band based on a difference between the plurality of waves represented by the plurality of the signals being acquired; and
a step of assessing condition of the pipe using a physical quantity of the determined frequency band as an index.

8. The condition assessment device according to claim 4, wherein a vibration exciter is installed at the one point.
